(19) United States
(12) Patent Application Publication
(10) Pub. No.: US 2026/0133064 A1
(43) Pub. Date: May 14, 2026

(54) SPATIALLY RESOLVING FILLING LEVEL MEASUREMENT

(71) Applicant: Endress+Hauser SE+Co. KG, Maulburg (DE)

(72) Inventors: Philipp Hügler, Aalen (DE); Winfried Mayer, Buch (DE)

(21) Appl. No.: 19/119,471

(22) PCT Filed: Sep. 13, 2023
(86) PCT No.: PCT/EP2023/075162

§ 371 Date: Apr. 9, 2025

(30) Foreign Application Priority Data
Oct. 26, 2022 (DE) 10 2022 128 393.3

(51) Int. Cl. G01F 23/284

(52) U.S. Cl. CPC G01F 23/284

(57) ABSTRACT

A radar-based, fill level measuring device operable with small computing power and small electrical power consumption for ascertaining spatially referenced fill level values is based on a convergent lens that is directed toward the fill substance so that radar signals are transmittable bundled toward the fill substance and receivable bundled after reflection. A plurality of radar-ICs are arranged relative to the fill substance behind the convergent lens with mutually differing offsets from the optical axis for producing and receiving the radar signals on the basis of which the positional resolution results. The radar signals experience defined, different deflections toward the fill substance. To ascertain the corresponding, spatially referenced fill level values, a control-evaluation unit controls the radar-ICs correspondingly.

The invention relates to a spatially resolving fill level measuring device as well as to a method for operating the fill level measuring device.

In process automation technology, field devices are applied for registering relevant process parameters. Suitable measuring principles are implemented in the field devices for registering process parameters such as fill level, flow, pressure, temperature, pH value, redox potential and conductivity. The most varied of such types of field devices are manufactured and sold by the “Endress+Hauser” group of companies

For fill level measurement of fill substances in containers, contactless measuring methods have proven themselves, since they are robust and low-maintenance. In such case, the terminology “container” within the scope of the invention includes also non-closed containers, such as, for example, vats, lakes and oceans plus flowing bodies of water. An advantage of contactless measuring methods is their ability to measure fill level virtually continuously. In the field of continuous fill level measurement, predominately radar-based measuring methods are applied (in the context of the invention, the terminology “radar” refers to signals, or electromagnetic waves, having frequencies between 0.03 GHz and 300 GHz).

An established measuring principle in such case is FMCW (“Frequency Modulated Continuous Wave”). The measuring principle of FMCW radar based distance measuring methods rests on transmitting a continuous radar signal having a modulated frequency. Characteristic for FMCW is that the transmitted frequency is changed periodically within a defined frequency band. Taking into consideration regulatory specifications, the higher frequency bands around standardized center frequencies are being used: besides the 6 GHz band, the 26 GHz band and the 79 GHz band, frequencies of 100 GHz and higher are being implemented. Advantageous for high frequencies is that a greater absolute bandwidth (for example, 4 GHz in the case of the 100 GHz frequency band) can be utilized. In this way, in turn, a greater resolution, or a greater accuracy, of the fill level measurement is achieved.

The change of frequency with time within the frequency band is, according to standard, linear and has a sawtooth- or triangular shape. A sinusoidal change can, in principle, also be implemented. Distance is determined in the FMCW method based on the instantaneous frequency difference between the currently received high frequency signal after reflection on the measured object, and the radar signal currently transmitted by the measuring device. The FMCW-based fill level measurement method is described, for example, in disclosure document DE 10 2013 108 490 A1.

With the FMCW method, it is possible to measure the distance, and/or the fill level, at least spotwise. In such case, the point at which the fill level is measured depends on the orientation of the transmitting-/receiving antenna, and on the direction of its beam lobe (due to the generally reciprocal properties of antennas, the characteristic, or the ray angle, of the beam lobe of the antenna is independent of whether it is sending or receiving; regarding the terminology “angle”, or “ray angle”, in the context of present invention, reference is to that angle, at which the beam lobe has its maximum transmitting intensity and receiving sensitivity).

In the case of liquid fill substances, where the fill level is usually uniform, measurement to any point on the surface is sufficient. In such case, the fill level measuring device is so oriented that the beam lobe of the antenna is directed, for instance, perpendicularly, downwards toward the fill substance and the distance to the fill substance determined in this way. In the case of solids-based fill substances, such as gravel or food or feed grain, the fill level can, however, be nonuniform, for example, due the heaping and funneling that bulk goods can undergo, so that the fill level value ascertained by the fill level measuring device is only conditionally informative. Especially in such cases, it is desirable to be able to determine distance, thus fill level, spatially resolved in the form of a two- or three dimensional profile. Besides exact volume estimation, especially the visual 3D-representation of imaging fill level measuring devices offers many benefits for automating filling processes and even processes in mining. Moreover, dangerous fill states can be noticed and prevented by the visualizing, this meaning, thus, that reliability and safety of corresponding process plants can be increased.

For spatially resolving, fill level measurement, the beam lobe of the radar-based, fill level measuring device can be made by mechanical means to execute a sweeping action, in order that the fill substance profile can be registered over the total container cross section or at least a portion thereof. Due to the increased maintenance effort, such forms of embodiment are, however, only used in special applications, such as, for example, in mining.

Also, radar-based distance measuring devices are known in the state of the art, in the case of which the beam lobe is electrically sweepable. Among others, the so-called “Phased-Array” principle can be utilized, in the case of which the measuring device has a number of antennas, wherein their radar signals are superimposed for evaluation. The antennas are arranged in a row (beam sweeping along one axis) or in an array (beam sweeping on two axes). In order to radiate, or to receive, the high frequency signal at defined angles, the individual antennas are operated according to their positions with a per antenna increasing phase shift. In such case, the angle α of the beam lobe depends on the phase shift φ according to

α˜arcsin(φ)

According to the state of the art, the hardware required for this can be integrated compactly such that the antennas are accommodated as patch antennas together with the semiconductor component for the signal production/signal evaluation on a shared circuit board, and even encapsulated together as a radar-IC (“Integrated Circuit”). A distance measuring device working according to the phased-array principle is described in, among others, DE 100 36 131 A1.

Besides the phased-array principle, spatially resolving radar measuring devices can alternatively also be designed based on digital beam forming (“Digital Beam Forming”).

In such case, each antenna of the antenna-array has its own signal processing and its own digitizing. The received signal is digitized both as regards its amplitude as well as also its phase difference using a corresponding method. The summing occurs digitally according to a virtual phase shift and amplitude scaling in a special computer, the so-called beam formation processor (“Beamform Processor”). With digital beam forming, the radiation characteristic of the antenna can be so formed that it has a plurality of independent main lobes for different directions.

Both by means of digital beam forming as well as also by means of the phased-array principle, it is possible to achieve a high lateral resolution of the fill level measurement. However, the signal processing is in both cases very complex and requires corresponding hardware, thus a corresponding computing power. However, especially electrical power consumption is greatly limited in the case of fill level measurement applications, due to explosion protection requirements.

It is accordingly an object of the invention to provide a spatially resolving fill level measuring device, which can be operated with small computing power and correspondingly small electrical power consumption.

The invention achieves this object by a radar-based, fill level measuring device for ascertaining spatially referenced fill level values of a fill substance in a container, comprising:
a convergent lens having an optical axis, which in the secured state is directed toward the fill substance, so that radar signals are transmittable bundled toward the fill substance and receivable bundled after reflection on the fill substance surface,
at least two radar-ICs, which are designed
   to produce the transmitted radar signals, and/or
   to receive the reflected radar signals after reflection on the fill substance and to generate therefrom, in each case, a received signal, by means of which a radar signal travel time is determinable.

According to the invention, the at least two radar-ICs are arranged relative to the fill substance behind the convergent lens and have defined, mutually differing offsets from the optical axis and are oriented toward the convergent lens. It is, in such case, not excluded that one of the at least two radar-ICs has an offset of zero from the optical axis, and further comprising
a control-evaluation unit, which is designed to drive the radar-ICs and to determine the signal travel times in such a manner that at least two spatially referenced fill level values are ascertained.

The terminology “unif” in the context of invention means, in principle, any separate arrangement or encapsulation of electronic circuits provided for the particular application, for example, for measurement signal processing or serving as an interface. The particular unit can, thus, comprise, depending on application, corresponding analog circuits for producing, or processing, analog signals. The unit can, however, also comprise digital circuits, such as FPGAs, microcontrollers or storage media in cooperation with corresponding programs. In such case, the program is designed to perform the required method steps, or to apply the necessary calculational operations. In this context, different electronic circuits of the unit can within the scope of the invention potentially also use a shared physical memory, or be operated by means of the same physical digital circuit. In such case, it is not important whether different electronic circuits within the unit are arranged on a shared circuit board or on a number of connected circuit boards.

Using the design of the fill level measuring device of the invention with a plurality of radar-ICs appropriately arranged relative to the convergent lens, the region of the fill substance surface can be registered with little hardware- and evaluation-effort without ambiguity errors, or deviations, resulting from possibly defective calibration. The fill level measuring device of the invention is also advantageous for the manufacturing in that the at least two radar-ICs can have a shared encapsulation.

In order to achieve a sufficient resolution of fill level measurement locations, it is advantageous that,
the number of radar-ICs,
the distance between the at least two radar-ICs,
the distance between the radar-ICs and the convergent lens,
the diopter of the convergent lens, and
the radar frequency of the radar-ICs
are matched to one another in such a manner that the resulting main radiation lobes of the radar-ICs have in the container an offset of maximum −10 dB relative to one another. For a uniform resolution, it is, moreover, advantageous that the at least two radar-ICs be arranged mirror symmetrically relative to the optical axis. On the other hand, these parameters should be so selected that the main radiation lobes have an offset of maximum −3 dB relative to one another, since otherwise the spatial unambiguousness of the measured fill level values is no longer assured.

In the context of the invention, it is not primary, which radar method is used for determining the individual travel times. The at least two radar-ICs can, for example, be appropriately designed to generate the radar signals, and the received signals, using the FMCW method or the pulse travel time method. Moreover, the fill level measuring device of the invention can be further developed by embodying and arranging the at least two radar-ICs in such a manner that they transmit the radar signals to the convergent lens, and receive such therefrom, with a narrower radiation cone, the greater the magnitude of the offset of the radar-ICs from the optical axis. In this way, the lateral resolution of the fill level values can be kept approximately constant over the height of the container.

In the simplest case, the monostatic operating method can be implemented in the fill level measuring device of the invention. In such case, the radar signal is transmitted and received, in each case, by the same radar-IC, in order to ascertain a corresponding fill level value L_{x;y} therefrom. Accordingly, the number of lateral positions, at which, in each case, a fill level value is ascertainable, corresponds to the number of applied radar-ICs. In order with the same number of radar-ICs to be able to determine fill level values at significantly more locations, it is advantageous, so to construct the control-evaluation unit that it drives the radar-ICs by means of the bistatic radar method, and determines corresponding fill level values. At least in the case of the bistatic method, it is necessary that all radar-ICs are clocked at high frequency by means of a shared clock source. In this way, it is assured that the radar signals transmitted by the different radar-ICs have the same phase difference.

The bistatic method is also insofar advantageous, that a plausibility check of ascertained fill level values can be performed for the fill level measuring device of the invention, whereby the operation of the process-plant is safer. The following method steps are applied for a plausibility check:
transmitting a radar signal by means of the first radar-IC,
receiving the corresponding radar signal via the second radar-IC after reflection on the fill substance surface,
ascertaining a first signal travel time based on the corresponding received signal,
ascertaining a second signal travel time by repeating the preceding method steps, wherein the two radar-ICs are exchanged as transmitter and receiver, and
classifying the fill level value as implausible, when the first signal travel time and the second signal travel time do not agree.

The invention will now be explained in greater detail based on the appended drawing, the figures of which show as follows:

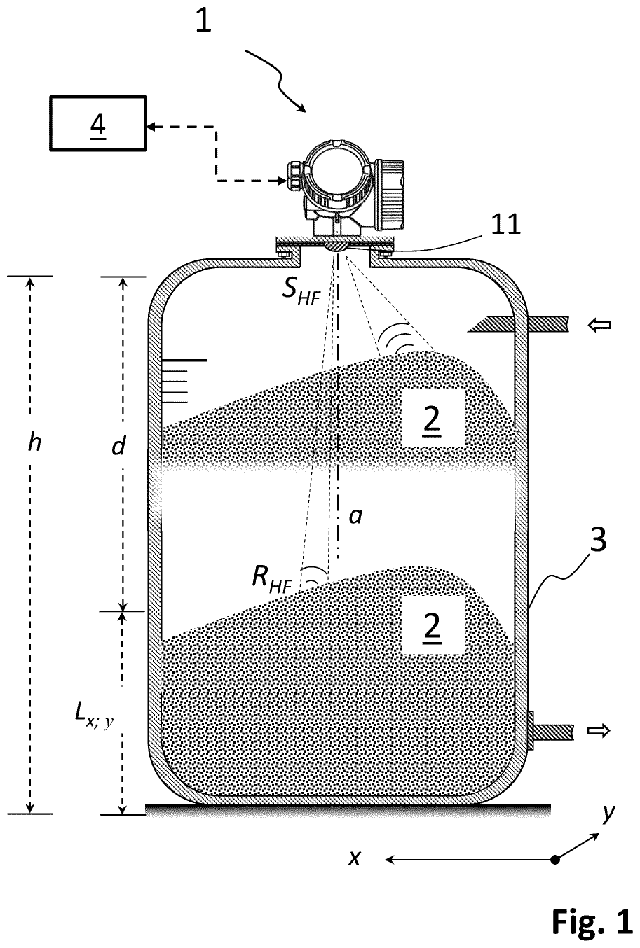

FIG. 1 a fill level measuring device of the invention on a container,

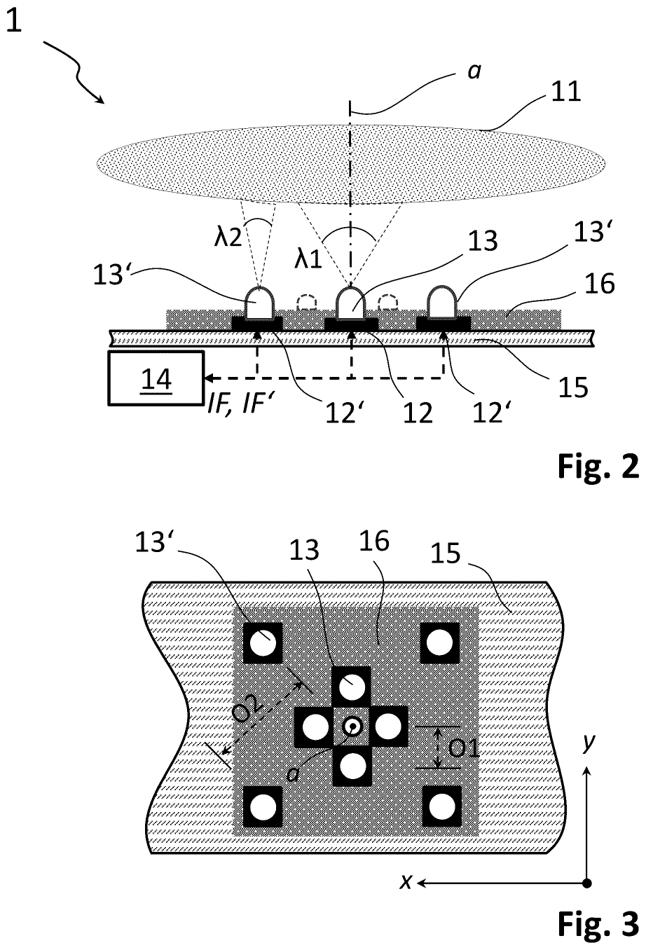

FIG. 2 a conceptual construction of the measuring device of the invention in cross section,

FIG. 3 a conceptual construction of the measuring device of the invention in plan view, and

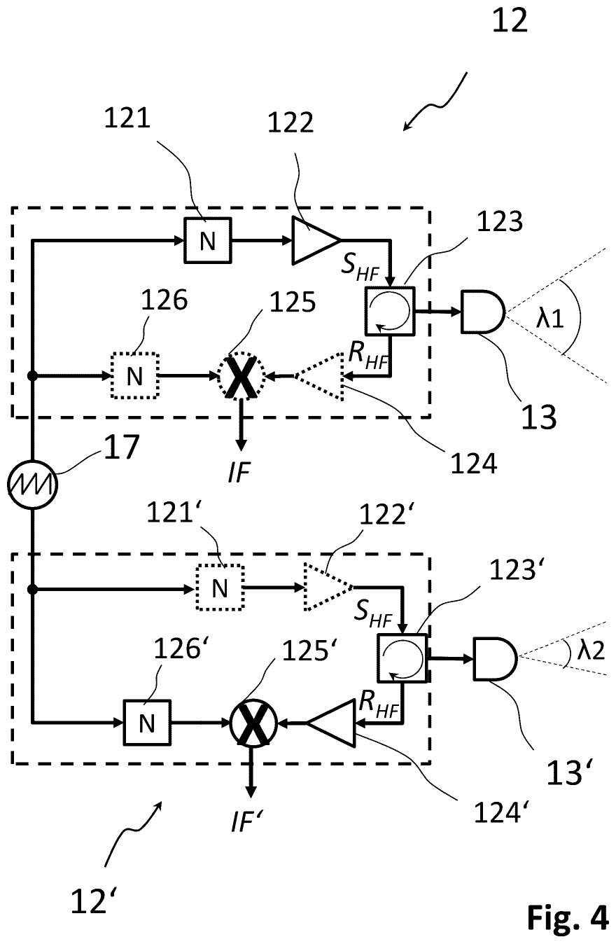

FIG. 4 a schematic block diagram of the measuring device of the invention.

For an understanding of the invention in principle, FIG. 1 shows a container 3 containing a fill substance 2, whose fill level L is to be determined. In such case, the container 3 can, depending on the type of fill substance 2 and depending on the field of application, be more than 100 m high.

In order to be able to determine the fill level L, a radar-based, fill level measuring device 1 is mounted above the fill substance 2 at a known, installed height h above the floor of the container 3. In such case, the fill level measuring device 1 is secured in such a manner at a corresponding opening of the container 3, such that radar signals S_{HF}, R_{HF} can be sent/transmitted, relative to a defined axis a, vertically downwards in the container 3 toward the fill substance 2, and received after their reflection on the fill substance surface. Accordingly, the fill level measuring device 1 can be arranged essentially outside the container 3.

After reflection of the sent/transmitted radar signals S_{HF} on the fill substance surface, the fill level measuring device 1 receives the reflected radar signals R_{HF}. In such case, the resulting signal travel time t between transmitting and/or receiving the respective radar signal S_{HF}, R_{HF} is correspondingly proportional to the distance d between the fill level measuring device 1 and the fill substance 2 according to

$$t = \frac{2 * d}{c} .$$

The parameter “c” is in this connection the media dependent, radar propagation velocity. For determining the signal travel time t, the FMCW- or the pulse travel time method can be implemented in the fill level measuring device 1. For example, based on a corresponding calibration, the fill level measuring device 1 can, in turn, relate the measured signal travel time t to the distance d. In this way, the fill level measuring device 1 can determine the fill level L at least pointwise according to

$$d = h - L ,$$

when the installed height h is furnished in the fill level measuring device 1.

As a rule, the fill level measuring device 1 is connected via a separate interface unit, such as, for instance, “4-20 mA”, “PROFIBUS”, “HART”, or “Ethernet”, to a superordinated unit 4, such as e.g. a local process control system or a decentral server system. In this way, the measured fill level values L can be transmitted, for example, in order to control possible in- and/or outgoing flows of the container 3. However, also other information concerning general operating state of the fill level measuring device 1 can be communicated.

As shown in FIG. 1, the surface of the fill substance 2 is not planar. Such can especially occur in the case of bulk goods-like fill substances 2, for example, when upon the filling of the container 3 the bulk goods form a cone. In addition, the outleting of the fill substance 2 leads to formation of a discharge funnel shape of the fill substance surface. When the fill level measuring device 1 determines the fill level L at only one spot on the surface of the fill substance 2, this can lead to a defective interpretation of the fill level L. In this way, an emptying procedure can be erroneously stopped, when the fill level measuring device 1 senses an empty container 3, even though fill substance 2 is still present toward the sides of the container interior. In the other case, it can occur in the case of a full container 3 that a filling-procedure is not paused, although a maximum fill level at a location of the fill substance surface has already been exceeded, since this is not detected by the fill level measuring device 1.

For this reason, the fill level measuring device 1 shown in FIG. 1 determines the fill level L_{x;y} spatially resolved, referenced to the plane x;y orthogonal to the axis a. Central component, in such case, is a lens 11 acting focusing for the radar signals S_{HF}, R_{HF}. In the case of the embodiment shown in FIG. 1, the convergent lens 11 also seals the fill level measuring device 1 from the fill substance 2. In such case, the convergent lens 11 in the secured state of the fill level measuring device 1 on the container 3 is oriented in such a manner that its optical axis a, along which the radar signals S_{HF}, R_{HF} are focusable, is directed vertically downwards toward the fill substance 2, as shown in FIG. 1. Preferably, the convergent lens 11 is so bound on the fill level measuring device 1 that the components located in the interior of the fill level measuring device 1 are encapsulated explosion conformly in the interior of the container 3.

In the interior of the fill level measuring device 1, thus, relative to the fill substance 2, behind the convergent lens 11, according to the invention, a plurality of radar-ICs 12, 12′ are provided. In such case, each of the radar-ICs 12, 12′ has a full valued functionality as regards pointwise distance measuring. The means that radar signals S_{HF}, R_{HF} can be produced, transmitted and received with each of the radar-ICs 12, 12′. Depending on implemented measuring principle, thus, for example, FMCW or the pulse travel time method, the particular radar-IC 12, 12′ generates, based thereon, its own received signal IF, IF′, to which a radar signal travel time can be assigned. In order to be able to determine the signal travel time t of a radar signal S_{HF}, R_{HF} between transmitting and receipt based on the received signal IF, IF′, the radar-ICs 12, 12′ are connected with a control-evaluation unit 14. In such case, the control-evaluation unit 14 ascertains the particular signal travel time t, and its fill level value L_{x;y} using the FMCW principle based on a Fourier transformation of the received signal IF, IF′.

FIGS. 2 and 3 show that the radar-ICs 12, 12′ are arranged on a circuit board 15 within the fill level measuring device 1. In the shown variant, all radar-ICs 12, 12′ are encapsulated together by, for example, a potting compound 16. In this way, a separate encapsulation of the individual radar-ICs 12, 12′ is avoided. The shared encapsulation 16 is transparent, so that the transmitting, and receiving, of the radar signals S_{HF}, R_{HF} by the radar-ICs 12, 12′ is not suppressed. Such can also be implemented, for example, by having the corresponding primary radiators extend above the encapsulation 16 and, thus, be free thereof. Suitable methods of manufacture for this include, among others, selective dispensing, suppressing with 3D printing, protective forms or protective films over the not to be potted, primary radiators (“Foil Assisted Molding”), which are then removed.

The circuit board 15 is so mounted in the interior of the fill level measuring device 1 that the radiation cones λ1, λ2, within which the radar signals S_{HF}, R_{HF} of the radar-ICs 12, 12′ are, in each case, transmitted and received, are oriented about in parallel with axis a of the convergent lens 11. In such case, the radar-ICs 12, 12′ are arranged, such as can be seen especially from FIG. 3, on the one hand, in mutually differing positions x, y on the circuit board 15 relative to axis a of the convergent lens 11, and, indeed, mirror symmetrically to the x- and y axes. On the other hand, the radar-ICs 12, 12′ are divided into two four-member groups, wherein, according to the invention, the groups differ in the magnitudes of lateral offset O1, O2 of the radar-ICs 12, 12′ from the optical axis a of the convergent lens 11.

As symbolized in FIG. 1, there results from the two different offsets O1, O2 that the radar-ICs 12, 12′ transmit and receive the radar signals S_{HF}, R_{HF} in the container 3 relative to axis a of the convergent lens 11 toward and from the fill substance 2 with two differently strong deviations. This enables the control-evaluation unit 14 to ascertain fill level values L_{x;y} laterally over an as broad as possible region of the fill substance surface. In the monostatic operating mode, the number m of registrable fill level values L_{x;y} equals the number n of radar-ICs 12, 12′, thus eight in the example of an embodiment shown in FIG. 3.

The lateral position x;y on the fill substance surface associated with the corresponding fill level value L_{x;y} results from the position, i.e. offset O1, O2, of the corresponding radar-ICs 12, 12′ on the circuit board 15 relative to axis a of the convergent lens 11, the ascertained distance value d, as well as the diopter number of the convergent lens. In order to register the fill level values L_{x;y} laterally in an as uniform as possible, tight raster, the diopter-number and the positions are preferably so selected that the resulting main radiation lobes of the radar-ICs 12, 12′ in the container 2 (see FIG. 1) have an offset of −10 dB or less. In the case of an overlapping of −3 dB or less, the orientation of the main radiation lobes is too large, or the angle of sight too overlapping.

In the case of the embodiment of the fill level measuring device 1 of the invention shown in FIGS. 2 and 3, the four radar-ICs 12′, which are arranged on the circuit board 15 with the offset O2 of greater magnitude from the axis a, have a narrower radiation cone λ2 than the radiation cone λ1 of the inner radar-ICs 12. In this way, the corresponding main radiation lobes of the radar signal S_{HF}, R_{HF} behind the convergent lens 11 toward the fill substance 2 are broader than the main radiation lobes of the inner radar-ICs 12 of offset O1, such as this is shown in FIG. 1.

FIG. 1 makes schematically clear in this connection that the relative to the optical axis outer main radiation lobes of radar signals S_{HF}, R_{HF} illuminate only higher fill levels L and, at least in the case of a relatively narrow container 3, are not usable for low fill levels L. With the wider main radiation lobes of the outer radar signals S_{HF}, R_{HF} in the case of higher fill levels L illuminated therewith, surface resolutions can be achieved, which are similar to those achieved with the narrow, inner main radiation lobes of the radar signals S_{HF}, R_{HF} in the case of low fill levels L. Since the number of pixels and spatially resolved fill level values L_{x;y} corresponds to the number of main radiation lobes and radar-ICs 12, 12′, complete illumination of higher fill levels L with exclusively narrow main radiation lobes would require a very large number of radar-ICs 12. Since for a good imaging for the user, the surface resolution for high fill levels L does not, however, have to increase, broader radiation lobes are sufficient for greater deposit angles and higher fill levels L and, according to the invention, only a limited number of lobes are required.

In order to set the radiation cones λ1, λ2 of the radar-ICs 12, 12′ correspondingly wide, or narrow, for example, radar focusing, primary radiators 13, 13′ can be mounted in front of the radar-ICs 12, 12′ in front of their planar antennas. On the whole, by using the inventive design of the fill level measuring device based on single-radar-ICs 12, 12′ associated with the convergent lens 11, a fill level profile with laterally sufficient resolution can be achieved over a large height range h of the container 3, without necessitating complex and, thus, power intensive, subsequent signal evaluation.

Based on the fill level values L_{x;y} ascertained at different positions x;y, the control-evaluation unit 14 can create a profile of the fill substance surface, for example, by means of interpolation. In such case, the profile of the fill substance surface can be displayed, either on a display of the fill level measuring device 1, or, for example, by the superordinated unit 4.

Besides the monostatic operating mode, the fill level measuring device 1 of the invention is, in principle, also operable in the so-called bistatic mode. For this, the operating mode can be set by the control-evaluation unit 14. An example of a circuit diagram of two radar-ICs 12, 12′, with which the radar signals S_{HF}, R_{HF} can be produced and received not only monostatically, but, also, bistatically, is shown in FIG. 4. In such case, the FMCW principle is implemented in the illustrated example, so that the radar-ICs 12, 12′ in FIG. 4 operate based on mixers 125, 125′. These serve for mixing the instantaneously transmitted radar signal S_{HF} with the radar signal R_{HF} received currently via the primary radiator 13, 13′. In this way, a received signal IF, IF′ is produced, whose frequency changes proportionally to the signal travel time, and, thus, the distance d. By read-out of this frequency (for example, by means of a fast Fourier transformation), the control-evaluation unit 14 can, in accordance with the FMCW principle, ascertain the corresponding signal travel time t.

Within the radar-ICs 12, 12′, the radar signal S_{HF} to be transmitted is fed via a transmitting/receiving duplexer 123, 123′ to the primary radiator 13, 13′, via which, moreover, the received radar signal R_{HF} can be forwarded to the mixer 125, 125′. In such case, the radar signal S_{HF}, R_{HF} is, as needed, amplified before the transmitting, and after receiving, in each case, by an amplifier 122, 122′, 123, 123′, which is arranged directly before or behind the transmitting/receiving amplifier 123, 123′. As regards bistatic measuring, advantageously at least the receiving amplifiers 124, 124′ have a sufficient reverse loss of especially >20 dB.

In addition to the signal amplification, the radar signal S_{HF} to be transmitted also undergoes a frequency multiplication. In the case of the embodiment shown in FIG. 4, for this, per radar-IC 12, 12′, in each case, an associated frequency multiplier 121, 121′, 126, 126′ with equal frequency multiplication factor N is provided, both in the sending path, as well as also in the receiving path, thus, before the transmitting/receiving duplexer 123, 123′ and before the mixer 125, 125′. This separate amplification in the sending path as well as also in the receiving path, above all, improves LO-suppression for the bistabile operation.

The frequency multiplication factor N of the frequency multipliers 121, 121′, 126, 126′ equals the quotient of the desired frequency of the radar signal S_{HF}, R_{HF}, divided by the frequency of the clock source 17 driving the radar-ICs 12, 12′. The clock source 17 can be implemented, for example, as an adjustable, phase controlled control loop (better known as “Phase Locked Loop, PLL”) for a VCO (“Voltage Controlled Regulator”). In this way, the frequency of the radar signal S_{HF} can be modulated time correspondingly with ramp shaped according to the FMCW principle.

In the case of the embodiment shown in FIG. 4, all radar-ICs 12, 12′ are driven by the same clock source 17. Such can be implemented, for example, by having the VCO of one of the radar-ICs 12, 12′ function supplementally as clock source 17 for all additional radar-ICs 12, 12′, while their VCOs are deactivated. In this way, phase equality of the radar signals S_{HF} transmitted from the different radar-ICs 12, 12′ is assured, this being essential for a bistatic operation of the radar-ICs 12, 12′. In contrast with monostatic operation, in the case of which the number of locationally dependent fill level values L_{x;y} is limited to the number of radar-ICs 12, 12′, a bistatic operation enables the registering of fill level values L_{x;y} at a greater number of positions x; y in the container 3 than the number of radar-ICs 12, 12′ present.

In addition to the fill level values L_{x;y} of the monostatic operating mode (the radar signal S_{HF}, R_{HF} in the monostatic operation is, in each case, transmitted and received by the same radar-IC 12, 12′, in order to ascertain therefrom the corresponding fill level value L_{x;y}), the radar signal S_{HF} in the bistatic operation is transmitted by the first radar-IC 12 and, after reflection, received by the second radar-IC 12′. For this, the components 124, 126, 121′, 122′ of the radar-ICs 12, 12′ cross-hatched in FIG. 4 are deactivated for the bistatic operation. In such case, the (de-)activating of these components 124, 126, 121′, 122′, and the coordination of the bistatic measuring, can be done by the control-evaluation unit 14. Counter to the showing of FIG. 4, the bistatic principle for spatially resolved fill level measurement can within the scope of the invention also be transferred to any number n of radar-ICs 12. In general, the theoretical maximum number m of locations, at which a fill level value L_{x;y} is registrable, amounts in the bistatic operation to

$$m = {\sum }_{i = 1}^{n} i$$

according to Gauss's empirical formula.

Especially relative to industrial fill level measurement, another advantage of the bistatic method is that fill level values L_{x;y} are testable for plausibility. This is possible in the context of invention, in that for those measurements, in the case of which the fill level value L_{x;y} is not registered monostatically, the pairwise functioning of the radar-ICs 12, 12′ as transmitter and receiver is reversed. In such case, in both constellations, a signal travel time and a corresponding fill level value L_{x;y} are registered. Logically, the results should be the same. If such is not the case, for example, due to a failure in the fill level measuring device 1, then an implausible fill level value L_{x;y} is assumed. For such a scenario, the control-evaluation unit 14 can, for example, be designed then to generate a corresponding disturbance message. This causes the fill level measuring device 1 to perform a corresponding self-diagnosis, in order to be able to report a possible malfunction to the superordinated unit 4. In this way, the risk of an uncontrolled process-state in the container 3 can be further reduced.

### LIST OF REFERENCE CHARACTERS

1 fill level measuring device
2 fill substance
3 container
4 superordinated unit
11 convergent lens
12 radar-IC
13, 13′ primary radiator
14 control-evaluation unit
15 circuit board
16 encapsulation
17 clock source
121, 121′ frequency multiplier in the transmission path
122, 122′ transmitting amplifier
123, 123′ transmitting/receiving separator, directional coupler
124, 124′ receiving amplifier
125, 125′ mixer
126, 126′ frequency multiplier in the receiving path
λ1, λ2 radiation cone width
a optical axis of the convergent lens
d distance
h installed height
L_{x;y} fill level value
m number m of locations x;y, at which a fill level value is registered
N frequency multiplication factors
n number of radar-ICs
R_{HF}, S_{HF} (reflected and sent) radar signals
O1, O2 offset
x;y position coordinates

1-10. (canceled)

11. A radar-based, fill level measuring device for ascertaining spatially referenced fill level values of a fill substance in a container, comprising:
a convergent lens having an optical axis that in a secured state is directed toward the fill substance so that radar signals are transmittable bundled toward the fill substance and receivable bundled after reflection on the fill substance surface;
at least two radar-ICs that are designed to produce the transmitted radar signals and/or to receive the reflected radar signals after reflection on the fill substance surface and to generate from the received radar signals a received signal by means of which a radar signal travel time is determinable, wherein the at least two radar-ICs are arranged relative to the fill substance behind the convergent lens and have defined, mutually differing offsets from the optical axis and are oriented toward the convergent lens; and
a control-evaluation unit that is designed to drive the at least two radar-ICs and to determine the radar signal travel time such that at least two spatially referenced fill level values are ascertained.

12. The radar-based, fill level measuring device as claimed in claim 11, wherein the at least two radar-ICs are designed to generate the radar signals, and the received signals using the FMCW method.

13. The radar-based, fill level measuring device as claimed in claim 11, wherein one of the at least two radar-ICs has no offset from the optical axis.

14. The radar-based, fill level measuring device as claimed in claim 11, wherein the at least two radar-ICs have a shared encapsulation.

15. The radar-based, fill level measuring device as claimed in claim 11, wherein the at least two radar-ICs are, for the case in which the fill level measuring device comprises more than two radar-ICs, arranged mirror symmetrically relative to optical axis.

16. The radar-based, fill level measuring device as claimed in claim 11, wherein the at least two radar-ICs are embodied and arranged in such a manner that they transmit the radar signals to the convergent lens, and receive such therefrom, with a narrower radiation cone, the greater the magnitude of the offset of the radar-ICs from the optical axis.

17. The radar-based, fill level measuring device as claimed in claim 11, wherein:
a number of the at least two radar-ICs
distances between the at least two radar-ICs,
distances between the at least two radar-ICs and the convergent lens,
a diopter of the convergent lens, and/or
a radar frequency of the at least two radar-ICs
are matched to one another such that resulting main radiation lobes of the at least two radar-ICs have in the container an offset of minimum −3 dB and/or maximum −10 dB relative to one another.

18. The radar-based, fill level measuring device as claimed in claim 11, wherein the control-evaluation unit is designed to drive the at least two radar-ICs via a bistatic radar method and to determine corresponding fill level values.

19. The radar-based, fill level measuring device as claimed in claim 18, wherein the at least two radar-ICs are clocked at high frequency via a shared clock source.

20. A method for testing a spatially resolved fill level value for plausibility by means of a radar-based, fill level measuring device, the method comprising:
providing the radar-based, fill level measuring device for ascertaining the spatially referenced fill level value of a fill substance in a container, including:
a convergent lens having an optical axis that in a secured state is directed toward the fill substance so that radar signals are transmittable bundled toward the fill substance and receivable bundled after reflection on the fill substance surface;
at least two radar-ICs that are designed to produce the transmitted radar signals and/or to receive the reflected radar signals after reflection on the fill substance surface and to generate from the received radar signals a received signal by means of which a radar signal travel time is determinable, wherein the at least two radar-ICs are arranged relative to the fill substance behind the convergent lens and have defined, mutually differing offsets from the optical axis and are oriented toward the convergent lens; and
a control-evaluation unit that is designed to drive the at least two radar-ICs and to determine the radar signal travel time such that at least two spatially referenced fill level values are ascertained;
transmitting the radar signals via a first radar-IC of the at least two radar-ICs;
receiving the reflected radar signals via a second radar-IC of the at least two radar-ICs after reflection on the fill substance surface;
ascertaining a first signal travel time based on the received signals;
ascertaining a second signal travel time by repeating the preceding method steps, wherein the first and second radar-ICs are exchanged as transmitter and receiver; and
classifying the fill level value as implausible when the first signal travel time and the second signal travel time do not agree.
